(19) United States
(12) Patent Application Publication
(10) Pub. No.: US 2010/0000750 A1
(43) Pub. Date: Jan. 7, 2010

(54) Impact Wrench

(75) Inventor: Benjamin Andel, Fuerfeld (DE)

Correspondence Address: CENTRAL COAST PATENT AGENCY, INC, 3 HANGAR WAY SUITE D, WATSONVILLE, CA, 95076, US

(73) Assignee: METABOWERKE GMBH, Nuertingen (DE)

(21) Appl. No.: 12/489,652

(22) Filed: Jun. 23, 2009

(30) Foreign Application Priority Data
Jul. 1, 2008 (EP) 08 011 816.9-1262

(51) Int. Cl. B25D 15/02; B25D 11/00; B23B 45/16

(52) U.S. Cl. 173/48; 173/217; 173/93

(57) ABSTRACT

The invention relates to an impact wrench having a drive motor for driving a drive shaft (30) and an output shaft (10) that can be coupled to a tool holder, and having an impact mechanism, the impact mechanism comprising an anvil (14) coupled to the output shaft (10), and having a hammer (20), which is guided on the drive shaft (30) and rotates with the latter in the case of non-impact and, in the case of impact, executes a rotational movement relative to the drive shaft (30), an actuating means (23) being provided for switching the impact mechanism between an operating mode with the impact mechanism switched on and an operating mode with the impact mechanism switched off, the actuating means (23), in a first position, the impact mechanism having been switched on, being in rotationally fixed engagement with the drive shaft (30) or the hammer (20), or being without engagement with the hammer (20) or the drive shaft (30), and, in a second position, the impact mechanism having been switched off, being in rotationally fixed engagement with the hammer (20) and the drive shaft (30), the actuating means (23) being axially movable for the purpose of switching.

The invention relates to an impact wrench for screwing and drilling, comprising a rotary impact mechanism, such impact wrenches being used, inter alia, to effect or undo high-tenacity screwed connections. Impact wrenches have been known in the prior art for many years, the functioning of the rotary impact mechanism being based on the idea of temporarily storing the drive power of a motor and periodically delivering it to an output shaft within a very short working phase. These periodically delivered rotary pulses generate, in dependence on the pulse duration, a resultant driving torque that is significantly higher than would be possible in the case of a constant torque characteristic. From the drive side, the system obtains kinetic energy in the form of torque and rotational speed, this energy being temporarily stored in a component, for example in a spring or a rotating mass. The storage operation in each case continues until a control mechanism causes the stored energy to be delivered to an anvil, via a hammer. For this purpose, both the anvil and the hammer of the impact mechanism have impact cheeks, the hammer comprising a rotating mass, which is constituted by the solid part of the hammer, the kinetic energy being transferred to the anvil through acceleration of this mass. The anvil in this case is connected to the output, i.e. also to the threaded fitting, in a rotationally fixed manner. The control mechanism causes the energy to be delivered to the anvil in a time-limited manner, such that the connection is released again when the stored energy has been delivered.

In this case, there are two working phases in the impact mechanism, the energy being collected and stored in phase 1, and the stored energy being delivered back in phase 2. The energy stored in phase 1 is in this case determined by the input quantities of torque, rotational speed and number of impacts. The greater the number of impacts of the impact mechanism, the shorter is phase 1 time-wise and the less the energy that can be stored, since the motor can only apply a predefined torque and, consequently, the duration of the storage operation is decisive.

In the second phase, the duration of the energy delivery is likewise decisive. If the stored energy is delivered to the output in a relatively short time, the impact duration is thus shorter, and the torque peak produced is higher than in the case of a longer impact duration.

Basically, the typical torque characteristic of an impact wrench is produced in that energy is temporarily stored over a relatively long period of time, which energy is delivered abruptly to the output in a very short period of time.

In the case of impact, no torque is produced at the output between the torque peaks. Owing to this design, high tightening and loosening moments are possible with a compact design. Nevertheless, the reaction moment that has to be absorbed by the person working with the impact wrench is only the moment that is required to accelerate the rotating hammer mass in the impact mechanism, or to tension the spring. It is comparatively small, compared with the output torque.

An impact wrench has been previously described in, for example, DE 43 01 610 A1.

It can be desirable in this case to provide a device that makes it possible to provide a switchover between an operating mode with the impact mechanism switched on and an operating mode with the impact mechanism switched off, in which device the screwdriver can be used as a simple screwdriver without rotary impact, or, also, as a drill/driver.

Already known in this case, from DE 43 01 610 A1, is the practice of realizing a switch-off device for the impact operation, the striker here being able to be fixed axially by means of a manually operable actuating device, without inhibiting the rotary drive of the drive shaft. In this way, the axial movement of the striker or hammer, and thereby a tensioning of the storage device for the impact energy, which storage device is realized as a spring in the prior art, is prevented.

Furthermore known, for example from EP 1 574 294 A2, is a design for an impact wrench, there being provided here an axially displaceable ring that acts together with the hammer in a first, impacting operating mode and, in a second operating mode, connects the hammer to the anvil, the ring acting together with both the hammer and the anvil and thus providing a rotationally fixed connection between the hammer and the anvil.

Finally, there is likewise known, from EP 1 762 343 A2, a device for switching on and switching off the impact function of an impact wrench, there being provided a pin that is axially displaceable in a groove and that, in one of the end positions in the output-side direction, blocks the movability of the hammer in the axial direction. The hammer thus remains in continuous engagement with the anvil, and the impact function is blocked. There is likewise already known from this publication the practice of providing a further shaft, which causes the power flow to bypass the impact mechanism. Upon deactivation of the impact function, a switching element causes this second shaft to be connected to both the drive side and the output side in a rotationally locked manner. At the same time, the connection of the drive to the impact mechanism is undone.

It is now the object of the invention to provide an actuating means for switching the impact mechanism on and off, said means having an alternative design solution and, at the same time, rendering possible particularly simple switchover between an operating mode with the impact mechanism switched on and an operating mode with the impact mechanism switched off.

The object of the invention is achieved by an impact wrench having the features of claim 1, namely an impact wrench having a drive motor for driving a drive shaft and an output shaft that can be coupled to a tool holder, and having an impact mechanism, the impact mechanism comprising an anvil coupled to the output shaft, and having a hammer, which is guided on the drive shaft and rotates in a rotationally fixed manner with the latter in the case of non-impact and, in the case of impact, executes an at least limited rotational movement relative to the drive shaft, an actuating means being provided for switching the impact mechanism between an operating mode with the impact mechanism switched on and an operating mode with the impact mechanism switched off, the actuating means, in a first position, the impact mechanism having been switched on, being in rotationally fixed engagement with the drive shaft or the hammer, or being without engagement with one of the two components, hammer or drive shaft, and, in a second position, the impact mechanism having been switched off, being in rotationally fixed engagement with the hammer and the drive shaft, the actuating means being axially movable for the purpose of switching. Such an impact wrench is also suitable for drilling, in addition to screwing.

Provision can be made in this case, in a first case of non-impact, whereby the hammer rotates with the anvil and the drive shaft, the impact cheeks of the anvil and of the hammer bearing against each other and being in engagement, i.e., being in contact in the axial direction, this operation being effected, the impact mechanism having been switched on, until the maximum torque of the wrench is achieved without impacting. That is to say, it is normally effected until a first blocking of the screwed connection occur. For the purpose of further tightening the screwed connection, a transition to impact operation is then effected automatically, the impact mechanism having been switched on, it being the case in impact operation that the anvil and the hammer no longer bear against one another continuously, as in the case of screwing, by means of their impact cheeks that are arranged on mutually facing faces of the hammer and the anvil, but are separated from one another during the storage of energy, in order then to strike on one another in the circumferential direction upon the discharge of energy, and consequently the impact, and thus to deliver a momentarily greater torque.

In this case, in the case of impact, the hammer can execute an axial movement relative to the drive shaft, in addition to the relative rotation relative to the drive shaft. The axial movement can be oscillatory.

In this case, for the purpose of switching off the impact mechanism in order to ensure screwing-only or drilling-only operation without the impact mechanism being switched on automatically, the drive shaft is connected to the hammer through axial displacement of the actuating means. In this case, the actuating means, in a first position, is coupled only to the drive shaft or to the hammer, or is without engagement with the two, and, in a second position, the hammer and the drive shaft are coupled to one another, such that no relative rotation occurs between them, and consequently the oscillatory movement in the axial direction is inhibited. In this way, there can be no storage of energy and no locking superposition of the impact cheeks.

Insofar as the actuating means is in engagement with the hammer and the drive shaft, it blocks the rotary relative movement between the hammer and the drive shaft that, in addition to the axial relative movement, renders possible the impact function.

Such a design, comprising an axially displaceable actuating means, which, in a first position and operating mode, is either without engagement or in engagement only with the drive shaft or the hammer, and which, in a second operating mode, the impact mechanism having been switched on, is in engagement with the hammer and the drive shaft, is particularly easily realized in respect of production engineering, it being particularly preferred that the switching operation can be effected irrespective of the relative angle of the components hammer and drive shaft in relation to one another. This switchover irrespective of the relative arrangement of the two components in relation to one another can be achieved, on the one hand, through the impact mechanism being designed, for example, as a V-groove impact mechanism that, when at a standstill, always has the same positioning of the hammer and drive shaft in relation to one another, but it can also be achieved through appropriate realization of the actuating means.

Particularly preferred as an actuating means in this case is an axially displaceable setting ring or an axially displaceable pin, the setting ring being able to have, in particular, one or more grooves or ribs that can be brought into engagement with grooves or ribs in the drive shaft and/or in the hammer and can be displaced along the groove longitudinal direction, which extends in the axial direction. Also conceivable are spirally arranged grooves, via which an actuating means capable of being displaced rotationally-axially can be brought into engagement with one or both of the components.

The actuating means can be actuated via a sliding switch, but also via a rotary movement at a ring in the case of an axial-rotary movement. Moreover, a turning grip can also be provided as the element by means of which the actuating means is moved, which turning grip, via an appropriate guide, renders possible a translational movement or a coupled, translationally rotary movement of the actuating element.

Provision can be made in this case whereby, in particular, for the purpose of actuating the actuating means, there is provided a sliding switch that projects through a housing opening and that is connected to the setting ring, the sliding switch, in particular, being guided in a groove that extends around the circumference of the setting ring, and rotating in the groove around the setting ring when the setting ring revolves with the drive shaft.

Particularly preferably, provision can be made in this case whereby the impact mechanism is realized as a V-groove impact mechanism, the hammer, in the case of impact, executing an axially oscillating rotational movement in respect of the drive shaft. An axially oscillating movement in this case is to be understood to mean that, in the case of impact, the hammer executing both an axial relative movement, the hammer being moved axially back and forth in a groove on the drive shaft, alternately in the direction of the drive-side end of the drive shaft and the output-side end of the drive shaft, the groove being realized in a V shape, and the tip of the V pointing in the direction of the output side of the shaft, a relative rotational movement of the hammer in relation to the drive shaft also being caused at the same time by the axial movement, owing to the V shape of the grooves. The hammer in this case can be guided via a ball guide in the V-grooves, preferably two V-grooves being arranged diametrically opposite one another on the drive shaft.

A V-groove impact mechanism in this case operates as follows: Prior to occurrence of an impact, the anvil, via its impact cheeks, which bear against the impact cheeks of the hammer, rotates together with the hammer and the drive shaft without any relative movement being effected between the individual components. Upon the presence of a relatively large torque, there then occurs a decoupling of the impact cheeks between the anvil and the hammer, owing to the fact that this greater torque cannot be applied through the normal tightening torque of the impact wrench. Owing to the drive-shaft rotation that is transmitted to the hammer, and owing to the counter-holding of the anvil, the hammer moves in the V-grooves on the drive shaft. Owing to the provision of the V-grooves, the hammer is moved away from the anvil at the same time as the rotation relative to the drive shaft, in the axial direction, and the impact cheeks of the hammer and of the anvil become superposed in a locking manner in the axial direction. Owing to the release of the hammer from the anvil, the hammer can again move freely in the rotational direction, and is accelerated by the stored energy that is stored in a spring through the axial movement of the hammer in the drive direction, until, at the end of its rotary movement and axial movement, it impinges, by means of its impact cheeks, against the impact cheeks of the anvil and thus executes, in the circumferential direction, an impact that results in a further tightening or loosening of the screwed connection that is being worked. After the impact, the impact mechanism is re-tensioned through axial and radial movement of the hammer.

According to a first embodiment, provision can be made whereby a groove or a rib is provided in the drive shaft and the hammer, it being generally possible also for a plurality of grooves or ribs to be provided, distributed over the circumference, which grooves or ribs act together with a corresponding rib or groove of the actuating means. Owing to the force being distributed to a plurality of ribs, the force can be better distributed and the elements designed to be matched thereto.

In principle, a tooth system can be provided on the actuating means, insofar as the actuating means is a sleeve or a ring, which tooth system acts together with a corresponding tooth system on the outer circumference of the drive shaft and hammer.

According to a particularly preferred design, provision can be made whereby the hammer consists of a separate rotating mass and a separate control part, the control part acting together with the anvil in the case of impact, and the rotating mass and the control part being connected to one another in a rotationally fixed manner, but being axially movable in relation to one another. In the case of provision of a V-groove impact mechanism, in particular, only the control part is axially movable in respect of the drive shaft. The division of the hammer into two elements, namely, the rotating mass and the control part, which are coupled to one another in a positively rotationally fixed, but axially displaceable, manner, gives the advantage that, since the rotating mass does not execute any axial movement, no vibration is caused in this direction. Only the control part executes the axial oscillation. Since the mass of the control part is significantly less than that of the total rotating mass, the vibration excitation in the direction of the axis of rotation is reduced considerably.

Moreover, provision can preferably be made whereby there is realized a torque setting that is effected, in particular, through variations of the biasing force of the spring of the V-groove impact mechanism.

According to a further preferred design, provision can be made whereby the impact wrench is a battery-powered impact wrench, battery-powered appliances normally having the advantage of being easier to use at any location, and also in difficult applications. Moreover, the impact function is advantageous in the case of battery-powered appliances particularly because, in the case of appliances having a direct electrical connection, the torque rating can be so effected that higher torques are achieved, such that, if appropriate, it is possible to work without an additional impact function.

Further advantages and features of the invention are disclosed by the other application documents. The invention is explained more fully in the following with reference to a drawing, wherein:

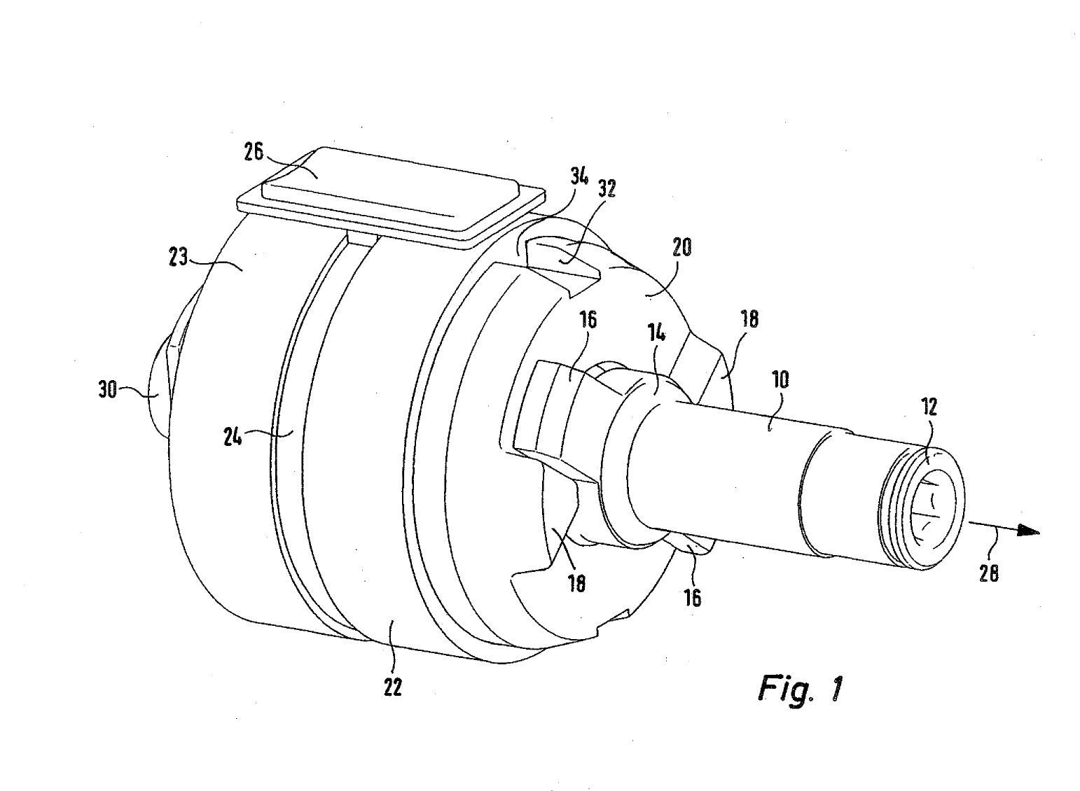

FIG. 1 shows an impact mechanism, in an assembled form

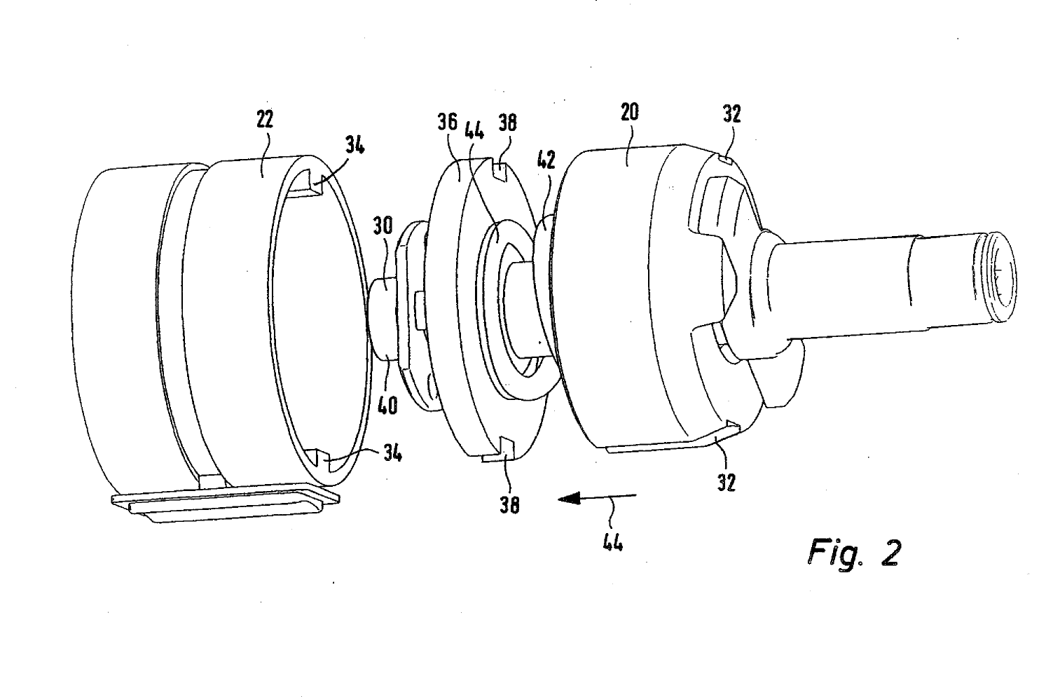

FIG. 2 shows a partially exploded representation of an impact mechanism

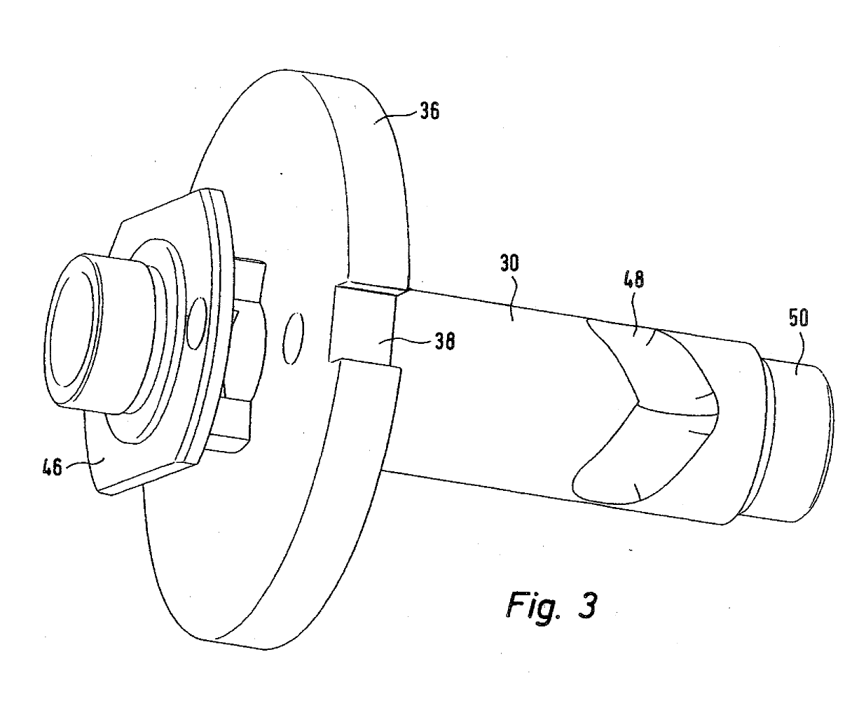

FIG. 3 shows a drive shaft

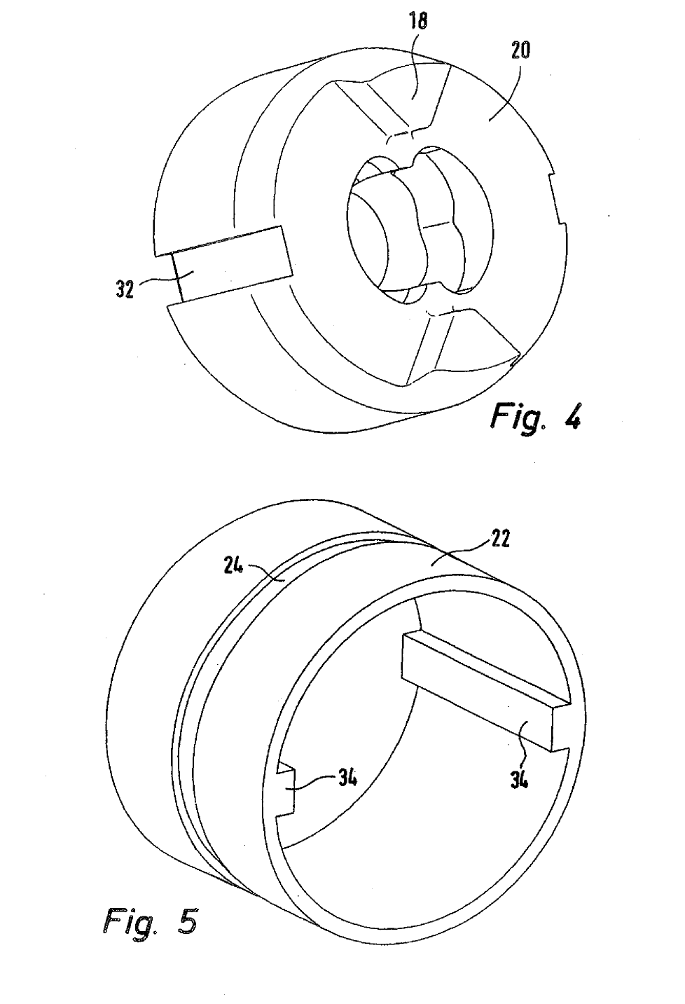

FIG. 4 shows a hammer

FIG. 5 shows a setting ring of an actuating means

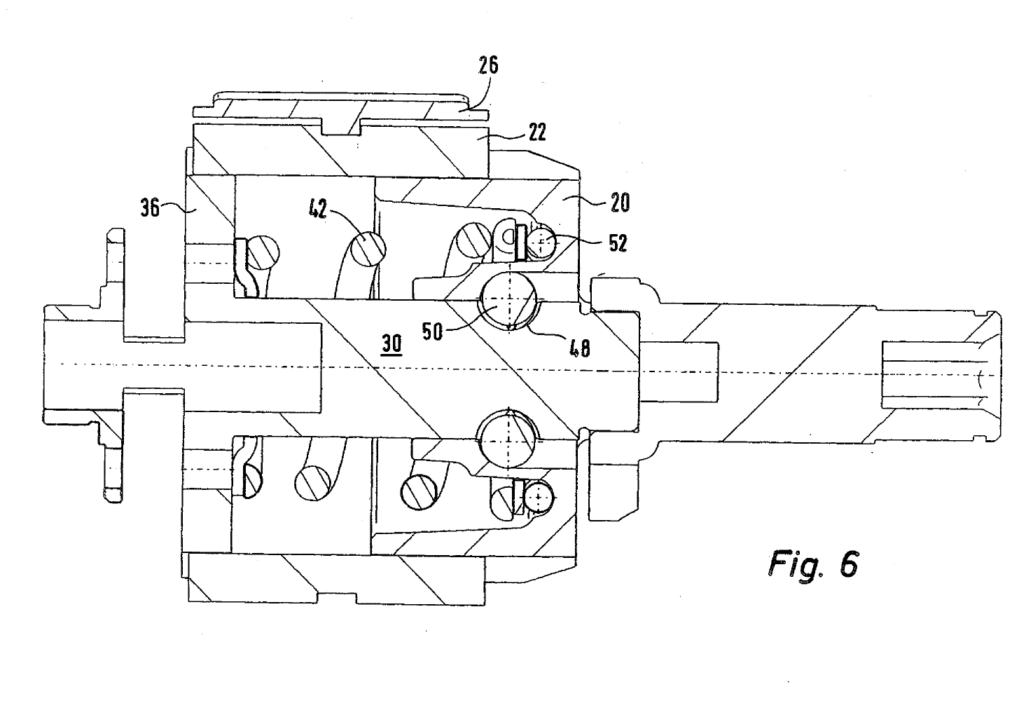

FIG. 6 shows a sectional representation through the impact mechanism, the impact mechanism having been switched off

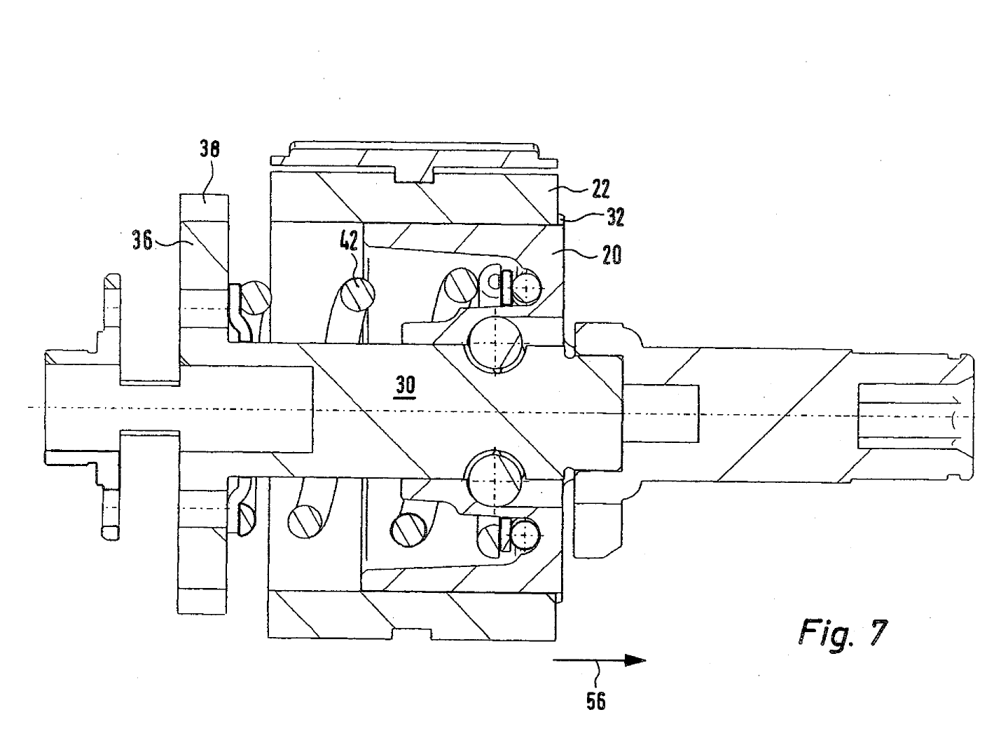

FIG. 7 shows a section through the impact mechanism, the impact mechanism having been switched on

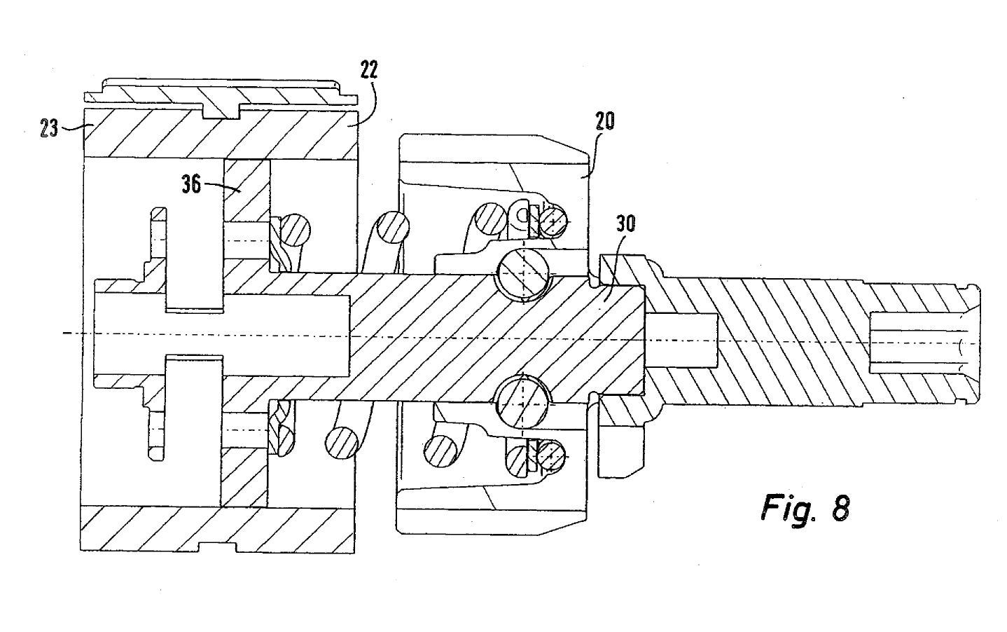

FIG. 8 shows an alternative design of the impact mechanism, the impact mechanism having been switched on

FIG. 1 shows an impact mechanism of an impact wrench, comprising an output shaft 10, which, at its output-side end 12, can be connected to a tool, in particular, a screwdriver, and which, at its drive-side end, has an anvil 14 having two impact cheeks 16 realized diametrically opposite one another in the radial direction, the impact surfaces being surfaces that extend substantially radially. The rectangular impact cheeks 16 of the anvil 14 act together with cake-portion-type impact cheeks 18 of a hammer 20, the impact cheeks 18 of the hammer 20 having impact surfaces that bear flatly against the impact surfaces of the impact cheeks 16 of the anvil 14. The hammer 20 in this case constitutes a rotating mass, on the one hand, and, on the other hand, serves as a control means for controlling an impact operation. Moreover, the impact mechanism comprises, as an actuating means 23, a setting ring 22 having a circumferential groove 24, in which there is guided a sliding switch 26 that extends through an opening of a housing of the impact wrench, a movement of the sliding switch 26 in the axial direction 28 causing the setting ring 22 to be displaced in the axial direction, the setting ring 22 being realized to be coaxial with the output shaft 10 and with the drive shaft 30, and surrounding, at least intermittently and at least partially, the drive shaft 30 and the hammer 20.

Realized in the hammer 20 in this case is a groove 32, in which a rib 34 of the setting ring 22 engages and thus effects a positive locking between the setting ring 22 and the hammer 20.

FIG. 2 now shows an exploded representation of the impact mechanism, wherein the setting ring 22 has been removed. In this case, the setting ring 22 has two ribs 34, which are diametrically opposite one another and which engage, respectively, in a groove 32 of the hammer 20, there likewise being provided in the drive shaft 30, in a flange 36 connected to the drive shaft 30 so as to constitute a single piece therewith, grooves 38, in which the ribs 34 can likewise engage. The drive shaft 30 in this case can be coupled, by means of its drive-side end 40, to a drive motor, it being possible, in particular, for a planetary gearing (not represented) to be interposed between the drive motor and the drive shaft 30, in order to transmit and to vary the rotational speed of the drive motor.

There is moreover provided a spring 42 that, by means of its output-side end, acts together with the hammer 20 and, by means of its drive-side end 44, bears against the flange 36 of the drive shaft 30. An axial movement in the direction 47 of the hammer 20 enables the spring 42 to be tensioned between the hammer 20 and the flange 36, and thereby enables energy to be stored in the spring 42.

FIG. 3 now shows the drive shaft 30 with the flange 36 and the grooves 38, and with a further flange 46 for connection to a transmission or to the drive motor, two V-shaped grooves 48 being provided in the drive shaft 30, at the output-side end 50 of the drive shaft 30, and the V-shaped groove serving to control the axially oscillatory rotational movement of the hammer 20 in relation to the drive shaft 30. The two V-grooves 48 are arranged oppositely. The hammer 20 is guided in the grooves 48 via ball guides (not represented).

The hammer 20 alone is represented in FIG. 4 in this case.

FIG. 5 now shows the setting ring 22, with the ribs 34 for axial guidance and positive connection, in particular, to the drive shaft 30 or to the hammer 20, or to both the drive shaft 30 and the hammer 20.

FIG. 6 shows a section through the impact mechanism, the setting ring 22 here engaging, by means of its ribs 34, both in the groove 32 of the hammer 20 and in the groove of the flange 36 of the drive shaft 30, and thus connecting the drive shaft 30 to the hammer 20 in a rotationally fixed and positive manner. Owing to this connection of the hammer 20 and the drive shaft 30, the relative rotational movement of the hammer 20 in relation to the drive shaft 30, to render possible the impact operation, is prevented, and the hammer 20 always rotates together with the drive shaft, and thus, by means of its impact cheeks 18, remains continuously in contact with the impact cheeks 16 of the anvil 14. In this way, a screwing-only or drilling-only function can be rendered possible.

FIG. 6 furthermore shows the ball guide 60 in the V-grooves 48 of the drive shaft 30, as well as the spring 42, which serves to store the energy that is subsequently discharged in the impact. Moreover, a bearing 52 is arranged in the interior of the hammer 20, such that only an axial loading of the spring 42 is effected, but no rotational loading is applied to the spring 42.

FIG. 7 shows an operating mode in which the impact wrench is in an operating state with the impact mechanism having been switched on, the setting ring 22 here engaging, by means of its rib 34, only in the groove 32 of the hammer 20, but not in the groove 38 of the flange 36 of the drive shaft 30. In this way, the hammer 20 can move, in respect of the drive shaft 30, both rotationally, to the extent predefined by the V-grooves, and axially in the direction 44, such that the impact cheeks 16 and 18 of the anvil 14 and of the hammer 20 become separated, and consequently the impact cheeks 16 and 18 become superposed in a locking manner, and subsequently the tension of the spring 42 is relieved and the hammer 20 is accelerated in the axial direction, denoted here by the arrow 56. When the spring 42 has been fully tensioned, the absence of contact with the anvil 14 and the guidance in the V-grooves result in a rotational movement of the hammer 20, with simultaneous axial movement of the hammer 20 in the output direction, which movement is then stopped by the impact cheeks 18 of the hammer 20 impinging upon the impact cheeks 16 of the anvil 14, and exerting upon the impact cheeks 16 of the anvil 14 a pulse, or impact, that then results in a momentary torque peak, which can be used for further tightening or loosening of a screwed connection.

FIG. 8, finally, shows a further design, the setting ring 22 here being in contact only with the groove 38 of the flange 36 of the drive shaft 30, and a relative movement in respect of rotation being thereby likewise rendered possible between the hammer 20 and the drive shaft 30, as well as an axial movement coupled therewith.

In principle, provision can also be made whereby the setting ring 22 is not in engagement with either the drive shaft 30 or the anvil 14, and an impact position is thereby rendered possible.

Switching-on and switching-off of an impact mechanism of an impact wrench can be achieved particularly easily, in respect of production engineering, in the manner described above. Moreover, by means of the blocking of the relative rotational movement and the provision of axially extending coupling elements, e.g. through the ribs in the setting ring 22, the force can be distributed to the setting ring 22 over a relatively large area and over the circumference, such that the service life of the appliance can be increased.

1. Impact wrench having a drive motor for driving a drive shaft and an output shaft that can be coupled to a tool holder, and having an impact mechanism, the impact mechanism comprising an anvil coupled to the output shaft, and having a hammer, which is guided on the drive shaft and rotates with the latter in the case of non-impact and, in the case of impact, executes a rotational movement relative to the drive shaft, an actuating means being provided for switching the impact mechanism between an operating mode with the impact mechanism switched on and an operating mode with the impact mechanism switched off, characterized in that the actuating means, in a first position, the impact mechanism having been switched on, is in rotationally fixed engagement with the drive shaft or the hammer, or is without engagement with the hammer or the drive shaft, and, in a second position, the impact mechanism having been switched off, is in rotationally fixed engagement with the hammer and the drive shaft, the actuating means being axially movable for the purpose of switching.

2. Impact wrench according to claim 1, characterized in that the actuating means is an axially displaceable setting ring.

3. Impact wrench according to claim 1, characterized in that the impact mechanism is realized as a V-groove impact mechanism, the hammer, in the case of impact, executing an axially oscillating rotational movement in respect of the drive shaft.

4. Impact wrench according to claim 3, characterized in that the drive shaft has at least one V-groove, and the hammer is guided in the V-grooves of the drive shaft.

5. Impact wrench according to claim 1, characterized in that the hammer and the anvil have, respectively, two diametrically opposing impact cams, which bear against one another and transmit the rotation in the case of non-impact and which, in the case of impact, execute a relative rotation and, in particular, axial movement in relation to one another, and impinge upon one another upon impact.

6. Impact wrench according to claim 1, characterized in that there is provided in the drive shaft and the hammer at least one groove or one rib that acts together with at least one corresponding rib or groove of the actuating means.

7. Impact wrench according to claim 1, characterized in that the hammer comprises a rotating mass and a control part, the control part acting together with the anvil in the case of impact, and the rotating mass and the control part being connected to one another in a rotationally fixed manner, but being axially movable in relation to one another.

8. Impact wrench according to claim 1, characterized in that the actuating means can be actuated by means of a sliding switch (26) that is connected to the actuating means and projects through a housing opening of a housing.

9. Impact wrench according to claim 1, characterized in that the impact wrench is a battery-powered appliance.
